(19) United States
(12) Patent Application Publication
(10) Pub. No.: US 2005/0197951 A1
(43) Pub. Date: Sep. 8, 2005

(54) Method of marketing polished gemstones

(76) Inventor: Jean-Paul Tolkowsky, Antwerpen (BE)

Correspondence Address: BROWDY AND NEIMARK, P.L.L.C.;624 NINTH STREET, NW, SUITE 300, WASHINGTON, DC, 20001-5303, US

(21) Appl. No.: 11/070,665

(22) Filed: Mar. 3, 2005

Related U.S. Application Data
(60) Provisional application No. 60/549,529, filed on Mar. 4, 2004.

(51) Int. Cl. G06F 17/60

(52) U.S. Cl. 705/37; 705/1

(57) ABSTRACT

A method of selling polished gemstones or jewelry pieces set with polished gemstones is presented. According to this method, the polished gemstone or the jewelry piece being sold is accompanied with a rough stone which is a part of the same unique piece of rough from which the polished gemstone is produced.

### FIELD OF THE INVENTION

This invention relates to a method of marketing polished gemstones (e.g., diamonds) or jewelry pieces set with polished gemstones.

### BACKGROUND OF THE INVENTION

Various technique have been developed to facilitate selling/purchasing diamonds and jewelry pieces set with diamonds, as well as to provide emotional and symbolic value of diamond jewelry.

US 2002/0072984 discloses a method and apparatus for the distribution and sale of a branded product. This technique is aimed at allowing a seller of a branded product, such as a diamond seller, to attract both buyers and retailers using a web site on the Internet. Buyers may register with the web site by providing personal identification information including a financial account identifier. Buyers may then receive information on a branded product and order the product online. If the product is ordered, it may be retrieved by the user at an independent or franchised retailer corresponding to the geographic location of the buyer or shipped to the buyer by that retailer. Such local retailers, as well as individual employees of the same, may register with the seller to sell the product. The local retailers may then provide inventory information and receive appropriate orders through the seller's web site. The local retailers and individual employees may receive compensation from the seller for sales of the product. Local retails may furthermore be rated based on sales of the product and may receive further compensation based on their rating and/or further criteria. Existing online commerce methods, such as banner advertising, may also be combined with the methods of the present invention.

U.S. Pat. No. 6,304,853 discloses an automated gemstone evaluation system for producing a gemstone evaluation report and method for doing the same. The automated gemstone evaluation system receives gemstone data unique to the gemstone being evaluated from the user via an input device, like a keyboard for a computer. The automated gemstone evaluation system further includes a processor, which determines a pricing estimate and generates an evaluation report. The evaluation report is communicated to the user via an output device, and preferably includes a summary description of the qualities of the gemstone. The system and method further allow for the input to be received from a user located remotely and for the output to be returned to the remotely located user.

Usually, when cutting or polishing a diamond, efforts are made to more effectively utilize the rough diamond weight, and to use all the material to productive ends. It is often the case that, prior to polishing the diamond, the rough diamond is sawn or cleaved into two or more parts, each of them being then polished into a separate diamond that can be sold. These diamonds, originated from the same rough diamond are then sold separately.

CA 2343448 discloses a principal for marketing and manufacturing of the goods comprising polished gemstones. The goods such as sets of two or more loose polished gems or jewelry articles contained a set in gems that are cut from the same rough stone. It provides consumers with higher emotional value of the items such as engagement and wedding rings and manufacturers with a method of adding higher value and usage of the rough gemstone material as well as new possibilities for promoting the sale of the loose gems or jewelry production.

### SUMMARY OF THE INVENTION

There is a need in the art for a technique of marketing and selling polished gemstones, in particular diamonds, that provides more benefits for the manufacturer, retailer and consumer.

The present invention solves the above problem by providing a novel approach for marketing and selling polished gemstones. This approach consists of selling a polished diamond together with (as one package) a piece of rough diamond, wherein both the polished diamond and the piece of rough diamond have identical origins from the same unique piece of rough.

It should be understood that the term “diamond” is used herein as referring to any other gemstone as well.

Thus, according to one broad aspect of the present invention, there is provided a method of selling/marketing polished gemstones or jewelry pieces set with polished gemstones, the method comprising accompanying the polished gemstone or the jewelry piece being sold, with a rough, unpolished stone which is a part of the same unique piece of rough from which the polished gemstone is produced.

According to another broad aspect of the invention, there is provided a method of selling polished gemstones or jewelry piece set with the polished gemstones, the method comprising:
by a retailer/manufacturer of polished gemstones or jewelry pieces set with polished gemstones, preparing and providing to a purchaser a package that includes the purchased at least one polished gemstone or the jewelry piece set with the at least one polished gemstone and includes a rough stone which is a part of the same unique piece of rough from which said at least one polished gemstone has been produced; and
allowing a receiver of said package to get, from said retailer or manufacturer, a polished gemstone produced from at least a part of said rough stone, for free of additional charge associated with the production of the polished gemstone from said at least part of the rough stone.

The package of polished and rough stones will preferably be accompanied by a dedicated certificate, indicating the same origins of both stones from the same rough. The certificate might also include data regarding the geographic origins of the rough diamond and those who has polished the diamond.

Further, this certificate will confirm that the receiver of the package may return to the retailer or manufacturer at any time, and get the rough stone cut and polished, free of charge. The cost of the polishing of the received rough stone might be incorporated in advance in the entire package price.

It should be understood that the receiver of the package may be the purchaser himself, or any other person who has received the package from the purchaser, for example as a gift.

The retailer or manufacturer may allow the receiver of the package to apply for polishing the rough stone at any time after he/she has received the package, or within a certain time period after the package has been sold.

According to yet another aspect of the present invention, there is provided a method for establishing business relations between a manufacturer/retailer of polished gemstones or jewelry pieces set with polished gemstones and a consumer, the method comprising:
when selling, by the manufacturer/retailer, a polished gemstone or jewelry piece with a polished gemstone, accompanying said polished gemstone or said jewelry piece with a rough stone which is a part of the same unique piece of rough from which the polished gemstone has been produced; and
allowing a consumer, who has received said polished gemstone or said jewelry piece accompanied with the respective rough stone, to get from said manufacturer/retailer a polished gemstone produced from at least a part of said rough stone, for free of additional charge associated with the production of the polished gemstone from said at least part of the rough stone.

According to yet another aspect of the invention, there is provided a gift case or package containing a polished gemstone or a jewelry piece set with a polished gemstone, and containing a rough stone which is a part of the same unique piece of rough from which the polished gemstone has been produced.

The gift case or package is preferably accompanied by a certificate indicative of at least one of the following: confirmation regarding the origins from the same rough, particulars of a manufacturer and/or retailer, and a confirmation that a receiver of said polished gemstone or the jewelry piece with the respective rough stone is allowed to get from the manufacturer or retailer at least a part of the rough stone polished, for free of additional charge.

### BRIEF DESCRIPTION OF THE DRAWINGS

In order to understand the invention and to see how it may be carried out in practice, an embodiment of the invention will now be described, by way of non-limiting example only, with reference to the accompanying drawing:

FIGS. 1A and 1B show schematically two examples of a gift case of the present invention.

### DETAILED DESCRIPTION OF THE INVENTION

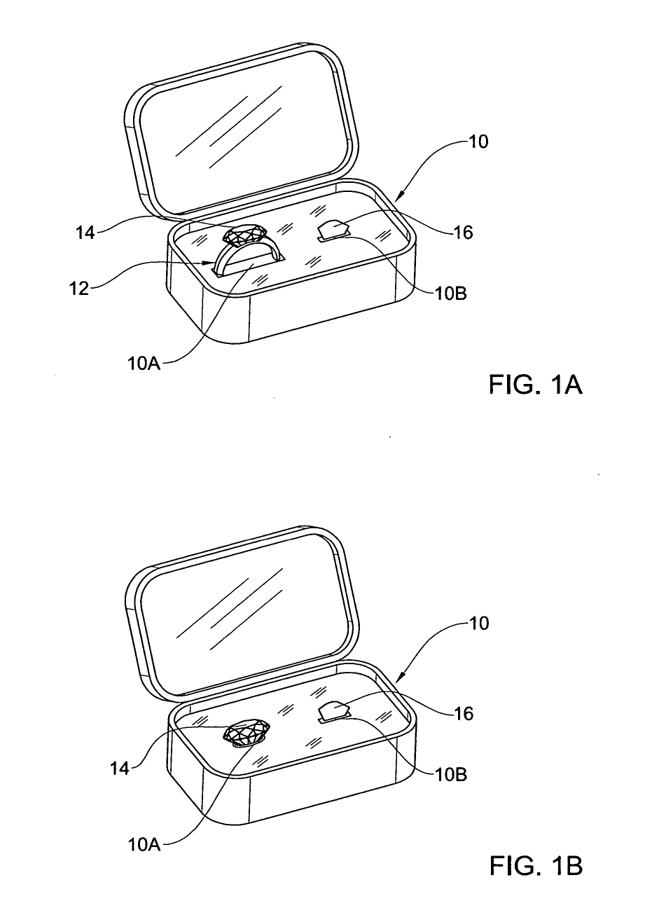

Referring to FIG. 1A, there is schematically illustrated a package (box) 10 for containing therein jewelry pieces or gemstones. The package 10 contains a part including at least one polished gemstone, which in the present example is constituted by a jewelry piece 12 (ring in the present example) in which at least one polished gemstone 14 (e.g., polished diamond) is set; and also contains a rough stone 16. The polished and rough stones 14 and 16 have identical origins from the same unique piece of rough. The package 10 may be configured to have separate compartments 10A and 10B for, respectively, the gemstone or jewelry piece, and the rough stone.

FIG. 1B shows another example of a gift package 10 containing therein a polished diamond 14 and: a rough stone 16 having identical origins from the same unique piece of rough. In the present example, the polished diamonds and the rough stone are located in separate compartments 10A and 10B, respectively, specifically prepared for this purpose. The package is preferably accompanied with a certificate of evaluation for the polished diamond produced by a recognized gemological institute. Such a certificate produces various characteristics of the diamond, such as its shape and cutting style, weight, clarity and color, which in turn define the value of the diamond.

The present invention takes advantage of the fact that the remainder of the rough 16, from which the polished diamond 14 is produced, can be used to produce one or more additional polished diamonds.

According to the technique of the present invention, a consumer, who has received (e.g., purchased or received from a purchaser) from a retailer/manufacturer such a package containing a polished diamond and a rough diamond of the same origin, is allowed for obtaining, from the same retailer/manufacturer, for free of charge, another polished diamond produced from at least a part of the rough diamond. The option of obtaining the polishing of the rough stone or part thereof for free of charge (or free of additional charge, considering that the cost associated with the additional polishing is included in the price of the original package) may and may not be limited to a certain time period after the package has been sold. The certificate (supplied by the manufacturer or retailer) accompanying the package may include confirmation that the receiver of the package is allowed to return to the retailer or manufacturer (at any time or within a certain time period), and get the rough stone polished (and possibly cut and polished), for free of charge.

The technique of the present invention provides the manufacturer with the opportunity to better utilize the entire piece of rough diamond, as well as highlights the innovative approach of the manufacturer with new and fresh ideas for promotion of loose or set polished diamonds. The retailer, in turn, is provided with the opportunity to add value to polished diamonds of his store. As for the consumer (receiver and/or purchaser), he is provided with confidence about the origin of the polished diamond and that the additional rough diamond may be polished, free of additional charge, from the piece of rough. This approach provides high emotional value for the consumer.

It should also be understood that allowing the receiver to return to the same retailer to get the rough stone cut and polished, might result in that the receiver purchases a new jewelry for this rough stone in its polished state and setting this stone in it, thus providing additional business for the retailer. Also, the receiver's visit at the retailer's shop might provide for establishing better long term business relations between the retailer and the receiver, or new such relations, in the case the receiver is not the purchaser of the original package of polished diamond and its respective rough stone, but received the package (e.g. as a gift) from the purchaser. Also, when getting into the retailer's shop, the receiver may see a new piece of jewelry he/she likes, and purchase it, thus increasing the income of the retailer and/or of the diamond manufacturer.

It should be further understood that selling/marketing such a pair of polished and rough diamond will generate unique promotion for the retailer among the public, and unique promotion for the diamond manufacturer among the public and among retailers, generating again more business for the retailers and the diamond manufacturer.

1. A method of selling/marketing polished gemstones or jewelry pieces set with polished gemstones, the method comprising accompanying the polished gemstone or the jewelry piece being sold, with a rough unpolished stone which is a part of the same unique piece of rough from which said polished gemstone is produced.

2. The method of claim 1, wherein said polished gemstone is a polished diamond.

3. The method of claim 1, wherein the polished gemstone or the jewelry piece, and the rough stone are sold in the same package.

4. The method of claim 1, wherein a receiver of said gemstone or jewelry piece and the respective rough stone is allowed to obtain, from a retailer or manufacturer of said gemstone or jewelry piece and the respective roughs stone, a polished gemstone produced from at least a part of said rough stone, for free of additional charge associated with the production of the polished gemstone from said at least part of the rough stone.

5. The method of claim 4, wherein the receiver is allowed to apply for the polishing of said at least part of the rough stone, for free of additional charge, at any time after he/she has received said polished gemstone or the jewelry piece and the respective rough stone.

6. The method of claim 4, wherein the receiver is allowed to apply for the polishing of said at least part of the rough stone, for free of additional charge, within a certain time period after said polished gemstone or the jewelry piece and the respective rough stone have been sold.

7. The method of claim 1, wherein a receiver of said gemstone or jewelry piece and the respective rough stone is allowed to obtain, from a retailer or manufacturer of said gemstone or jewelry piece and the respective rough stone, a polished gemstone produced from at least a part of said rough stone, a cost associated with the production of the polished gemstone from said at least part of the rough stone being included in advance in a price of said gemstone or jewelry piece and the respective rough stone.

8. The method of claim 7, wherein the receiver is allowed to apply for the polishing of said at least part of the rough stone, for free of additional charge, at any time after he/she has received said polished-gemstone or the jewelry piece and the respective rough stone.

9. The method of claim 8, wherein the receiver is allowed to apply for the polishing of said at least part of the rough stone, for free of additional charge, within a certain time period after said polished gemstone or the jewelry piece and the respective rough stone have been sold.

10. The method of claim 1, wherein the polished gemstone or the jewelry piece and the respective rough stone are accompanied by a certificate indicative of at least one of the following: confirmation regarding the origins from the same rough, particulars of a manufacturer and/or retailer, and that a receiver of said polished gemstone or the jewelry piece with the respective rough stone is allowed to get at least a part of the rough stone polished, for free of additional charge.

11. The method of claim 10, wherein the receiver is allowed to get said at least part of the rough stone polished, for free of additional charge, at any time after he/she has received said polished gemstone or the jewelry piece with the respective rough stone.

12. The method of claim 10, wherein the receiver is allowed to get said at least part of the rough stone polished, for free of additional charge, within a certain time period after said polished gemstone or the jewelry piece with the respective rough stone have been sold.

13. A method of selling polished gemstones or jewelry pieces set with polished gemstones, the method comprising:
by a retailer/manufacturer of polished gemstones or jewelry pieces set with polished gemstones, preparing and providing to a purchaser a package that includes the purchased at least one polished gemstone or the jewelry piece set with the at least one polished gemstone and includes a rough stone which is a part of the same unique piece of rough from which said at least one polished gemstone has been produced; and
allowing a receiver of said package to get, from said retailer or manufacturer, a polished gemstone produced from at least a part of said rough stone, for free of additional charge associated with the production of the polished gemstone from said at least part of the rough stone.

14. A method for establishing business relations between a retailer/manufacturer of polished gemstones or jewelry pieces set with polished gemstones, and a consumer, the method comprising:
when selling, by the manufacturer/retailer, a polished gemstone or jewelry piece set with a polished gemstone, accompanying said polished gemstone or said jewelry piece by a rough stone which is a part of the same unique piece of rough from which the polished gemstone has been produced; and
allowing a consumer, who has received said polished gemstone or said jewelry piece accompanied by the respective rough stone, to get from said manufacturer/retailer a polished gemstone produced from at least a part of said rough stone, for free of additional charge associated with the production of the polished gemstone from said at least part of the rough stone.

15. A gift case or package containing a polished gemstone or a jewelry piece set with a polished gemstone, and containing a rough stone which is a part of the same unique piece of rough from which the polished gemstone has been produced.

16. The gift case or package of claim 15, including a certificate indicative of at least one of the following: confirmation regarding the origins from the same rough, particulars of a manufacturer and/or retailer, and a confirmation that a receiver of said polished gemstone or the jewelry piece with the respective rough stone is allowed to get from the manufacturer or retailer at least a part of the rough stone polished, for free of additional charge.
